(19) United States
(12) Patent Application Publication
(10) Pub. No.: US 2007/0203858 A1
(43) Pub. Date: Aug. 30, 2007

(54) Method and apparatus for enabling use of design software with a price based on design complexity

(75) Inventor: Carl C. Olsen, Vashon, WA (US)

Correspondence Address: GRAYBEAL, JACKSON, HALEY LLP, 155 - 108TH AVENUE NE, SUITE 350, BELLEVUE, WA, 98004-5901, US

(73) Assignee: OMAX Corporation

(21) Appl. No.: 11/698,447

(22) Filed: Jan. 26, 2007

Related U.S. Application Data
(60) Provisional application No. 60/763,862, filed on Jan. 30, 2006.

(51) Int. Cl. G06F 17/00

(52) U.S. Cl. 705/400

(57) ABSTRACT

A computer software product and method provides a capability to charge for use of software based on the complexity of the processing to be performed. The complexity of design software processing may correspond to the complexity of shapes received as input to the design.

### CROSS REFERENCE TO RELATED APPLICATIONS

This patent application claims priority benefit from and incorporates by reference U.S. Provisional Patent Application Ser. No. 60/763,862; entitled METHOD FOR CHARGING FOR USE OF DESIGN SOFTWARE WITH CUSTOMER OPTION BASED ON COMPLEXITY; invented by Carl Olsen; filed on Jan. 30, 2006.

### TECHNICAL FIELD

This disclosure relates to computer-aided-design software and systems, and more particularly to computer-aided-design software and systems configured to charge for use based on the complexity of parts comprising the design.

### BACKGROUND

Computer software has been developed for automating many design functions, including drawing, creating designs for parts to be manufactured, creating designs for buildings to be built, and designing paths for a movable head of a computer-controlled machine tool. Unfortunately, the relatively high costs of coding and supporting such software may necessitate a price or seat license that is relatively expensive. Such a price barrier may be especially difficult for occasional users to bear. Moreover, it may be difficult to develop or document pass-through software use costs to customers of designers, fabricators, etc.

These and other shortcomings may be addressed by embodiments described herein.

### OVERVIEW

According to an embodiment, a price for using computer-aided design software may be set as a function of the complexity of a design.

According to an embodiment, design software includes an estimator module to estimate the amount of time that would be saved for a human designer by using the design software to assist with creation of the design instead of completing the design without using the software.

According to an embodiment, the estimate is run using the estimator module and presented to the user, and the user is asked if he is willing to pay an amount of money which is calculated based on the amount of time that the estimator module has estimated will be required for a designer to prepare the design without using the specialized design software.

According to an embodiment, the price to be paid by the user is a function of the complexity of the particular job. For example, for a simple job where the amount of time to be saved is small, the price is low. For a complex job where the amount of time to be saved is high, the price is high.

According to an embodiment, the user is given the option to accept the price presented by the software or to reject it. According to embodiments, network communications may be used to enable the specialized design software to be used for the project if the user has agreed to make the specified payment; otherwise, the software will not be usable to assist with the requested design.

Software modules implementing embodiments may be particularly useful where significant mathematical computations are required. Such computations can be performed quickly by the computer. For example, if pieces are to be cut from a material, the process of determining which pieces should be cut from which portion of the material and how the pieces should be nested (e.g., placed beside and within each other) to make the most efficient use of the material can involve many options with geometric complexity that can be quickly solved using geometric mathematics. However, it may be relatively time consuming for a user to make these calculations without specialized software designed for this purpose. Also, for movable heads on a machine tool performing a complex process, one path may be better than another. Such paths may be determined much more quickly using a computer.

Other aspects and embodiments will become apparent in the appended brief description of the drawings, detailed description, figures, and claims.

### BRIEF DESCRIPTION OF THE DRAWINGS

FIG. 1 is a flow chart illustrating a process for setting a price for use of computer-aided design software based on complexity of a design, according to an embodiment.

FIG. 2 is a flow chart illustrating a process for offering a price for use of computer-aided design software and, responsive to user agreement, enabling output of a design, according to an embodiment.

FIG. 3 is a flow chart illustrating a process for providing interactive design capability and offering a use price as a function of estimated time saved through use of the design capability, according to an embodiment.

FIG. 4 illustrates a relatively simple nesting layout of a plurality of parts to be cut from a raw material.

FIG. 5 illustrates a second nesting layout of a plurality of parts to be cut from a raw material having a relatively higher complexity.

FIG. 6 is a state diagram illustrating a structure for receiving design input, optimizing part nesting, setting a price based on a value of processing provided, and enabling output responsive to receipt of payment, according to an embodiment.

FIG. 7 is a state diagram illustrating a structure for receiving design input, setting a price based on calculated value of processing, and enabling part nesting optimization and output responsive to receipt of payment, according to another embodiment.

FIG. 8 is a diagram of a computer network operable to perform computer-aided design and output results responsive to receipt of payment based on part complexity, according to an embodiment.

### DETAILED DESCRIPTION

A numbering convention to facilitate easy understanding by the reader is used herein. Figures are numbered in conventional consecutive order. Specific features are generally indexed consecutively using three or four digit numbers in the order described. The first one or two digits correspond to the figure number in which the feature is first described. Features having similar functionality generally retain their originally assigned number throughout, even though their physical or logical appearance may vary considerably from figure to figure.

There are various processes for computer aided manufacturing that involve cutting pieces from a material. One such category of processes is cutting using a beam or jet such as laser, electron, plasma, water jet, or abrasive water jet. In such applications, the best path to be followed by the beam or jet may be determined more quickly using specialized software. The same applies to other processes involving the motion of a tool-head relative to a work piece, including milling machines, spray painting machines, electrode position machines, electro-discharge machining, wire EDM, machines that build up a part by triggering the polymerization of a liquid polymer (e.g. UV cure), sintering, punch presses, ink jet manufacturing processes, sewing pattern design and manufacture, etc.

One such application, where the amount of time potentially saved by use of specialized software may be significant compared to the amount of time required for drafting without the specialized software; is the determination of an optimized nesting arrangement between parts to be cut from a sheet of material, such as in abrasive jet cutting. According to an embodiment, the shapes of each part to be cut are provided to a computer system in the form of CAD entities, along with a specification of kerf that must be allowed between adjacent cut pieces, quantity of shapes, and dimensions of the raw material to be cut. With this information, specialized nesting software can apply prior art algorithms to test possible layouts of the pieces on the material to be cut to determine an efficient configuration.

According to an embodiment, one adds to such prior art nesting software or other specialized design software a module that prevents it from providing a desired output until authorization has been received. Authorization may, for example, be in the form of an authorization token received across a computer network. One approach may be to transmit and receive the authorization token a secure means that allows the token to be effective without revealing to the user information that would allow the user to simulate the receipt of such a token in the future. Alternatively or additionally, a variable unlock key may substantially prevent a given code value to be used more than once to enable the design software. These and other methods for selectively controlling or enabling the use of computer software are known in the prior art.

According to an embodiment, an estimator module that estimates the amount of time or effort that would be required for the user to create the design without use of the specialized software is included. According to an embodiment, the estimator module may take into account effects such as part or shape complexity, raw stock size constraints, part quantity, and or other effects.

According to an embodiment, a price calculation module applies a pre-determined or dynamically calculated price model to set a use price as a function of the estimated time savings. According to an embodiment, the price calculation module may receive information across a network from the vender of a software system, an electronic bid system, etc.; such that prices or price determination algorithms may be determined dynamically or modified periodically.

According to an embodiment, a user interface module may activate the estimator module and the price determination module and then present to the user a price to be charged if the user wishes to use the software for the particular job presented. If the user responds in the affirmative, the user interface module then communicates with a server run by or for the vendor of the software system to make an electronic charge to an account for the user and, if the charge is authorized, returns a token that, when provided to the module which controls use of the software, allows the software to be used for that job.

According to an embodiment, a server module may update the pricing or price algorithm in the customer pricing module, receive the charge request from the customer, obtain a charge authorization for the account specified by the customer, and return a usage authorization token to the software running on a client computer. The client computer may then responsively allow the specialized design software to be used to create the design.

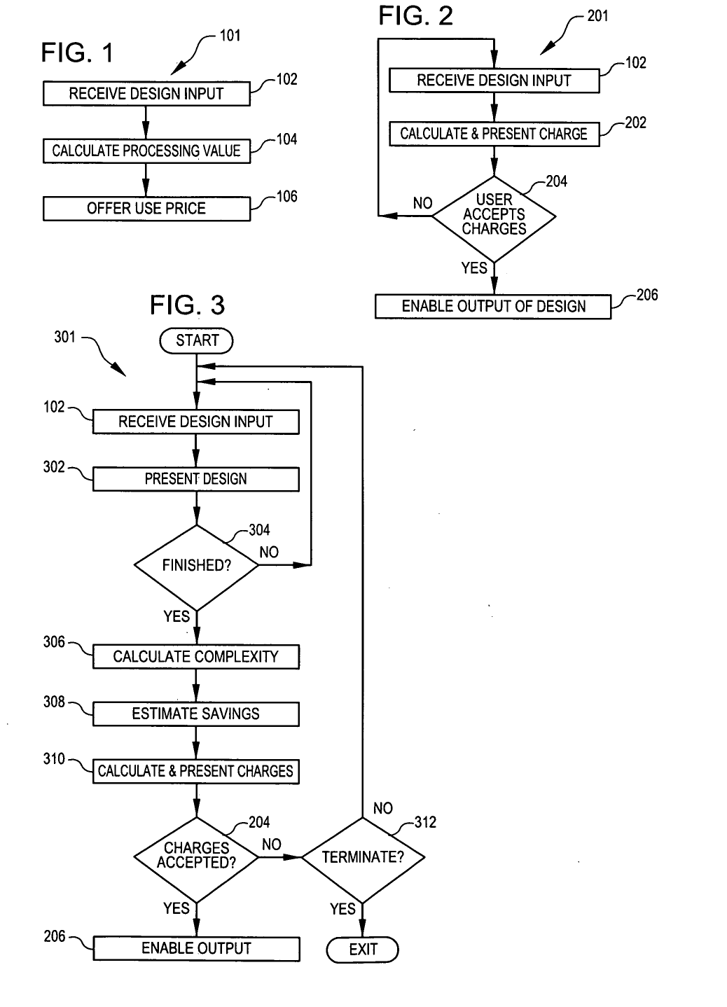

FIG. 1 is a flow chart illustrating a process 101 for setting a price for use of computer-aided design software based on the complexity of a design, according to an embodiment. The process 101 may be performed by an application program and/or by networked resources. In block 102 the system receives design input. Such design input may include, for example, one or more of one or more shapes to be cut, molded, hydro-formed, electrode posited, or otherwise formed; shape quantities; assembly specifications; raw stock specifications; raw stock size or sizes; draft angle requirements; tolerances; surface finish requirements; etc. Such input may be made real-time and/or may rely on upload/downloading of pre-determined design input. Design input may be made by an external design program or may be made in an application for which per-use charging will be performed.

Proceeding to step 104, an estimator module calculates a processing value. The processing value may be a function of some or all of the design input and may additionally rely on external variables or constants. According to an embodiment, a design computer such as a nesting optimizer may run a final or provisional design optimization, while the number of instructions processed, clock cycles consumed, or other measure of computational complexity is monitored. The measure of computational complexity may then be converted into a value and used to determine a price for using the software. According to another embodiment, actual or abstracted attributes of the design input may be used to drive an algorithm or table look-up that directly or indirectly determines a price.

Attributes of a design that may be used as input to determine a use price include: complexity of parts to nest including: number of corners in a part, number of arcs in a part, number of features in a part (e.g. holes, etc.), number of elements making up a part (e.g., a square would have four elements), curvature, and symmetry; complexity of the nest of parts including: number of parts to nest, number of different parts to nest; dissimilarity of parts, complexity of each part, and complexity of the sheet or sheets to nest; features enabled for the nest including: whether or not to common line cut, whether or not to automatically tab pieces, whether or not to automatically create a tool path sequence, and whether or not to bridge pieces; process constraints; assembly specifications; raw stock specifications; raw stock size or sizes; draft angle requirements; tolerances; surface finish requirements; grain or directionality (also referred to as anisotropy) of the raw material; the need to control grain direction of material in a part; raw stock cost; shape price target; and tool path efficiency target. Some or all of the listed attributes and other non-listed attributes may be used to determine complexity.

Other approaches may be used to determine price. According to embodiments, an output or intermediate value determined for the processing value may be converted into a manual effort equivalent, for example in hours required for manually performing the design task.

Proceeding to step 106, the determined price may be presented to the user to accept or not accept. Such presentation may include a presentation of a price for use of the software. Such a price may be in a currency amount, or alternatively may be in the form of credits such as credits-on-deposit, credits accumulated through rebates or other award-derived accumulations, etc. Additionally, the presentation of step 106 may include a presentation of hours saved, a price-per-hour basis, deductions such as use incentives, quantity rebates, market adjustments, etc. Additional presentation may include display of information intended to urge the user to make a positive purchase decision.

While terms such as “price” and “purchase” are used herein, such terms should be regarded broadly. For example, the “purchased” use of the software may include payment of a license, royalty fee or, alternative forms of consideration. The use of the software may include literal use of the software, access to output from the software, local running of the software, access to the software remotely such as through a browser, use of the software by another user, access to parts manufactured according to output from the software, and other tangible or intangible benefit derived from the software. For example, according to an embodiment, the software may be provided at no cost, and the output data files made usable through “purchased” authorization.

FIG. 2 is a flow chart illustrating a process 201 for offering a price for use of computer-aided design software and, responsive to user agreement, enabling output of a design, according to an embodiment. In block 102, the system receives design input. Proceeding to block 202, which according to some embodiments may be a combination of blocks 104 and 106 of FIG. 1, the system calculates a price to charge for use of the software and presents the price to the user.

Proceeding to step 204, the user makes a selection of whether or not to accept the price. According to some embodiments, the user may elect not to pay the price, but rather return to block 102 as indicated by the “NO” branch of decision block 204. Return to the design input block 102 may allow the user to modify the design such as by adding additional design elements or specifications, removing a portion of the design elements or reducing specifications, etc. to later return to block 202 and evaluate the marginal cost or savings for various design combinations. In this way, the user may interactively select a portion of design work he wishes the design software to perform with the intent of performing another portion of the design manually. According to some embodiments, the price structure may be set to encourage the user to select all or a large portion of the design to be performed by the software, such as by using variable weighting of processing value. If the user decides to accept the presented price, he may be presented with options and facilities for payment such as by using a third party payment service, an on-line storefront, addition of the price to a material purchase, etc. According to some embodiments, the user may save the design session without making a final software use purchase decision. The user or another party may then review one or several design sessions at a later time (or simultaneously in the case of another party) and make the purchase decision.

Following an affirmative decision and processing of payment in block 204, the program proceeds to block 206 where output of the design is enabled. According to some embodiments, the highest processing value is in the derivation of instructions such as tool paths for computer-controlled machinery. In such cases, step 206 may include making tool path calculations, and/or may include allowing previously calculated tool path descriptions to be released from a secure memory or storage to a user-accessible memory or storage.

Subsequent sessions may further allow a user to add additional design input in step 102, have the price determined for the incremental input in step 202, and be presented with a decision in block 204 of whether to add the additional design input to the previously created output. Such a calculated price may include a premium amount (which may or may not be presented to the user) associated with adding an incremental amount to an existing design.

FIG. 3 is a flow chart illustrating a process 301 for providing interactive design capability and offering a use price as a function of estimated time saved through use of the design capability, according to an embodiment. FIG. 3 includes some explicit description of what may be included in the processes 101, 201 presented in FIGS. 1 and 2, respectively. After receiving design input in step 102, a design may be presented to the user in step 302. According to embodiments, such presentation may include a graphical presentation of a design. For example, for a design system that produces a nesting layout for parts to be cut from raw stock, a graphical representation of the part layout may be provided. According to some embodiments, the presented layout may include a substantially exact layout such that the user may see precisely what layout decisions the nesting optimizer made. Alternatively, the presented layout may include a degree of ambiguity to prevent the user from seeing the substantially exact layout until and unless payment is made. According to an embodiment, step 302 may include a listing of specifications received in step 102. For example, it may include a list of shape names and or a thumbnail representation of the shapes, quantity to be made, and other specified requirements.

Proceeding to step 304, if the desired design input is not complete the process loops back to step 102 where additional or modified design input is received. Thus, the loop through steps 102, 302, 304 may provide an interactive design input session with the system providing design feedback as the session proceeds. According to the embodiment, the user is thus allowed to spot and correct layout issues, input errors, etc. prior to being presented with a purchase decision, and also receives feedback on a design as it proceeds. According to some embodiments, such feedback may help to improve a user's time and/or psychological investment in a design and may help to secure a positive purchase decision. Once a design input, or a provisional design input has been completed, the user may respond in the affirmative to a question posed in step 304, or may alternatively make an unprompted choice to proceed to the next phase. The program then proceeds to step 306.

In step 306, the complexity of the software design calculation is determined. As described above, several variable and constant values may be incorporated into the calculation. In one example, the complexity of shapes to be nested in a nesting optimizer is included in variables used to calculate the complexity in step 306. Step 306 may be performed subsequent to the completion of the design input and feedback loop of steps 102, 302, 304. Alternatively, step 306 may represent retrieval of previously determined values. According to an embodiment, the software whose services are offered is operative during the 102, 302, 304 loop. In such a case, step 306 may include monitor and/or retrieval of computer resources consumed during processing. In this way, step 306 may be included within the 102, 302, 304 loop, for example being performed prior to step 302, as the design software performs calculations necessary to present the design in step 302.

Following calculation of the complexity of the design, the process proceeds to step 308, where a savings estimate is performed. The savings may represent the output of a table look-up or algorithm that operates on the output of step 306 to provide an estimate of time saved by avoiding manual processes and/or design entry processes in alternative (e.g., competitive) design software products. As described above, the savings may be included in subsequent presentation to the user. Proceeding to step 310, the estimated savings such as time savings are combined with additional information to calculate a price, and the price is presented to the user. Such additional information may include, for example, hourly rate information that may adjusted to the user's location, the amount of time used during design input, the relative demands on system resources, time-of-day, day-of-the-week, time-of-year, the user's previous experience with the system, the volume of design input previously made by the user, the user's previous rate of accepting charges, the user's payment history, the user's credit score, existence of promotional pricing, additional services purchased or determined likely to be purchased by the user, and other factors.

Proceeding to step 204, the system may receive an election by the user to pay for the services and process payment, following which the system proceeds to step 206, where output is enabled as described elsewhere. Alternatively, the user may elect not to pay for services, upon which the process proceeds to block 312 where it is determined whether the user or the system wishes to terminate the session. A system termination decision may be made, for example, upon reaching a maximum loop count and/or other indication that the user is not likely to make a purchase. If neither the system nor the user elects to terminate, the program returns to step 102 where additional or replacement design input may be received.

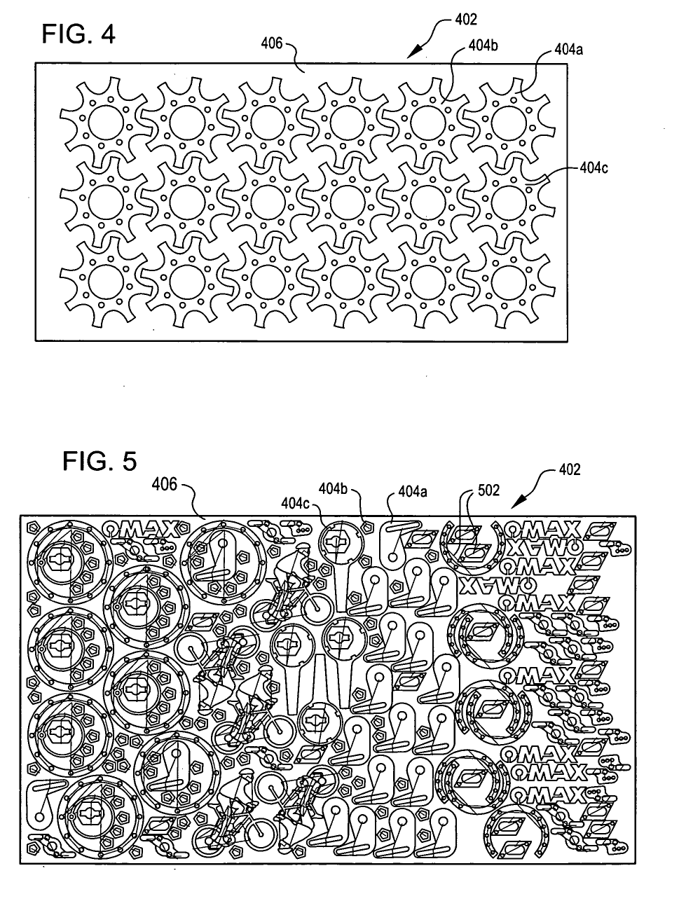

As indicated above, one application for the system described herein includes the determination of nesting layouts for nested parts to be cut from a raw stock. FIG. 4 illustrates a first nesting layout 402 of a plurality of parts 404 to be cut from a raw material substrate 406. Such a nesting layout may include optimization of material usage and optimization of tool movements. As may be seen, the parts 404 illustrated in FIG. 4 are relatively simple, and the layout of the parts is relatively simple. Thus the layout 402 of FIG. 4 may represent a design for which a relatively low price is set.

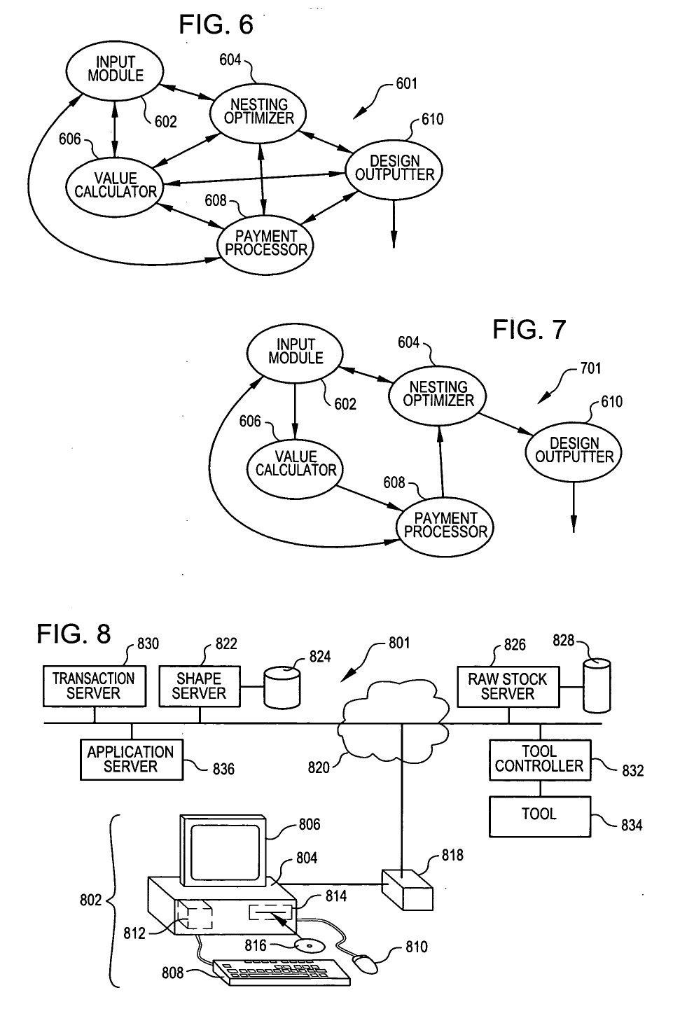

FIG. 5 illustrates a second nesting layout 402 of a plurality of parts 404 to be cut from a raw material substrate 406. Tool movement lines 502 indicate the path that a tool will take during movements between cut lines in a cutting operation. The layout 402 of parts 404 of FIG. 5 represent shapes that are relatively more complex and/or tool movement paths that are relatively more complex than those of FIG. 6. For example, to achieve the highest material yield, several parts include a relatively large amount of interdigitation or overlap. Depending on geometry of the parts and raw material, such overlaps may be relatively time-consuming to manually layout. Thus, the layout 402 of FIG. 5 may represent a design for which a relatively high price is set.

As mentioned above and elsewhere in this document, one approach to determining a processing value is to simply measure the computing resources consumed in processing a design. FIG. 6 is a state diagram 601 illustrating a structure for receiving design input, optimizing part nesting, setting a price based on a value of the provided processing, and enabling output responsive to receipt of payment, according to an embodiment. An input module 602 interacts with a nesting optimizer 604 interactively, and the nesting optimizer provides part nesting information via a graphical user interface (not shown). The nesting optimizer module 604 consumes system resources as it calculates optimum nesting configurations and tool paths. As the nesting optimizer 604 operates, a value calculator 606 monitors the consumption of system resources. The value calculator 606 applies table look-ups and/or algorithmic functions to calculate a value and a price for services provided by the nesting optimizer 604. The calculation of value and price may be carried out in parallel with operation of the nesting optimizer 604, or may be carried out subsequent to completion of a nesting optimization. The value calculator presents a processing price, royalty, value, and/or other information (such as advertising, etc.) to the user through the input module 602 and/or the graphical user interface (not shown).

Upon making or receiving a terminate decision, the value calculator 606 may terminate a design session and end processing by the input module 602 and nesting optimizer 604. Upon receiving a purchase decision, the value calculator 606 may call a payment processor 608 to process payment for the computing services provided by the nesting optimizer 604.

The payment processor 608 may include an on-line storefront, a third party payment processor, an account debiting resource, etc., and may interact directly with the user (such as through a graphical user interface), through the input module 602 as shown, or may interact with the user through the value calculator as also shown. After payment is received or otherwise processed, the payment processor 608 may inform the value calculator 606, and the value calculator enable the nesting optimizer 604 to continue and output the design. Alternatively, the payment processor 608 may directly interact with the nesting optimizer 604 to enable output. Alternatively the value calculator 606 or the payment processor 608 may interact with a design output module 610 to enable output of the optimized nesting layout and/or tool path determined by the nesting optimizer 604. The design outputter 610 may enable deriving the tool path determination or may receive a previously determined too path. The design outputter 610 may allow output of tool paths to a tool controller and/or may allow output of tool paths and/or nesting design to a user accessible resource such as memory or storage. Alternatively, the design outputter 610 may simply provide decryption of a nesting design and tool path provided by the nesting optimizer 604.

Upon completion of a design output by the nesting optimizer 604 and/or design outputter 610, the respective module may inform the value calculator and/or payment processor to validate completion of the process that had been authorized and/or paid for by the user. According to various embodiments, the user may be presented with a completion message and the message and activity logged. According to some embodiments, the completion of payment processing may be delayed until the nesting optimizer 604 and/or design outputter 610 has informed the value calculator 606 and/or payment processor 608.

The logical connections between modules 602, 604, 606, 608, and 610 shown in FIG. 6 may include more connections than are present in any single embodiment, but illustrate a range of data interchange pathways. Alternative connections and/or different groupings of modules are possible and with the range of one having ordinary skill in the art.

As mentioned above and elsewhere herein, another approach to determining a price for using a computer design resource involves making a calculations based on characteristics of the design input rather than being based on computer resources consumed by the design processor. FIG. 7 is a state diagram illustrating a structure 701 for receiving design input, setting a price based on calculated value of processing, and enabling part nesting optimization and output responsive to receipt of payment, according to another embodiment. In contrast with the system of FIG. 6, data received by the input module 602 may be used to drive a nesting optimizer 604 without consuming resources of the nesting optimizer for designs that are not subsequently paid for. For example, the input module 602 may receive a list of part descriptions, quantities, specifications, etc. that include some degree of complexity. That degree of complexity may be determined or received by the value calculator 606. The value calculator 606 then calculates a processing value and price for presentation to the user. Such presentation may be made directly through a graphical user interface (not shown), through the input module 602 (logical connection not shown), or through a payment processor 608 as shown. Upon receipt of payment, the payment processor 608 may enable the nesting optimizer 604 to communicate with the input module 602 and perform the processing services for which payment or provisional payment had been received. The nesting optimizer 604 may then output a calculated design directly or through a design outputter 610, as shown. As with FIG. 6, alternative and/or additional module integration and/or logical connections are possible.

While FIGS. 6 and 7 have illustrated, for ease of comprehension by the reader, a particular type of design system that determines layout and cutting paths for arrays of parts to be cut from a raw material, alternative types of computer-aided-design processing, computer-aided-manufacturing processing, and/or other non-design-related processing may similarly fall within the scope hereof. Some alternatives are listed above.

A computer and network system 801 diagrammatically shown in FIG. 8 represents a platform on which embodiments may be practiced, according to an embodiment. The client computer 802 of FIG. 8 includes a CPU 804, a video monitor 806, and optional data entry devices such as a keyboard 808 and mouse 810. The computer further includes a storage device 812 such as a hard drive, and optional removable media storage devices such as optical drive 814 operable to receive a removable media optical disk 816. The computer may include other wireless or wired connections (not shown) for interfacing with peripheral devices such as printers, solid-state media, CNC machinery, etc. The computer 802 may also have a network connection 818 such as a router and/or modem, etc. providing an interface to a network 820. Software embodiments may be loaded onto the computer 802 from computer readable media such as an optical disk 816, electrical or optical signal received through the network connection 818, a USB drive (not shown), or other media, for example.

A network 820, which may include a LAN, WAN, MAN, the Internet, etc. includes provision for connecting computers 802 to servers and other client devices. One or more shape servers 822 may provide access to a database of shapes 824 that may be retrieved for a design. Alternatively, shapes may be obtained through search through non-specified resources, may be retrieved from local storage 812, or may be designed in a current design session such as a design session performed on a client computer 802. Shapes may be retrieved and specified for inclusion in a design.

A raw stock server 826 may be provided to deliver information about available raw stock. For example, for a manufacturer who cuts successive jobs from a set of raw stocks, the raw stock server may include a database 828 that tracks available raw stock sizes and grades. Such raw stock sizes may, for example, include selvage or other unused portions from earlier jobs or other jobs in queue for fabrication. In such a case, the design software may query raw stock servers 826 and determine optimized use of not only new, nominally sized raw stock, but also raw stock remaining from earlier or other jobs that may otherwise go to waste. A plurality of raw stock servers 826 may be operative to provide raw stock inventory information from a plurality (e.g., a corresponding plurality) of raw stock suppliers.

A transaction server 830 may provide a bank of credits, may operate an on-line store for purchasing credits, etc. The transaction server may further provide a resource for the estimator and pricing modules, thus securing the code running therein and preventing unauthorized modification of estimator and pricing algorithms or table lookups.

After authorization, the design application may output tool control codes to one or more tool controllers 832 programmed to control tools 834 to cut or form designs such as nested shapes. According to an embodiment, the tool may be include a water jet or abrasive jet cutting mechanism. According to embodiments, the tool controller 832 may be integral to or separate from the controlled tool 834.

According to an embodiment, the design application may be enabled to provide an encrypted output that may be uploaded to a network resource such as the transaction server, etc. The encrypted design may then be stored and later enabled for decryption and transmission to a tool controller 832.

Embodiments may be run on an individual computer 802 and may optionally access resources spread across other computers 802 or on networked resources such as servers 822, 826, 830, 836, and tool controller 832, . Programs may be run locally or may be accessed on a server. Various embodiments may be run on peer-to-peer, client-server, host-terminal, or other network environments.

While resources for performing aspects according to embodiments are shown distributed across a network, other combinations may be envisioned. For example, a design application may be accessed on a server 836 by a browser running locally. The application server 836 may similarly provide a shape database, raw stock database, and transaction facility. Alternatively, a complete application having a bank of credits may be loaded and run locally in the client computer 802. Additional credits may then be downloaded as needed from a transaction server. Alternatively, a user agreement may allow a seat to use design software repeatedly without explicit quote and acceptance by the seat. Rather, the transaction server may monitor use and subsequently bill the user for cumulative designs tried and/or completed during a billing cycle. Such billing may be made with customer data added or may be made directly to customers of the user of the client computer 802. The transaction server may additionally accept third party requests for designs and route such designs to subscriber clients 802 for execution of the design, the transaction server then billing the third party for use of the software and, optionally, for fees forwarded by the subscriber. As may be appreciated still other combinations may comprise embodiments.

The preceding overview, brief description of the drawings, and detailed description describe exemplary embodiments according to the present invention in a manner intended to foster ease of understanding by the reader. Other structures, methods, and equivalents may be within the scope of the invention. As such, the scope of the invention described herein shall be limited only by the claims.

What is claimed is:

1. A method for providing computer-aided design processing, comprising:
calculating a processing value based on part complexity; and
offering a use price corresponding to the processing value.

2. The method for providing computer-aided design processing of claim 1, further comprising:
receiving design input.

3. The method for providing computer-aided design processing of claim 1, wherein calculating a processing value further comprises:
calculating a time value corresponding to manual processing; and
wherein the calculated processing value corresponds to the time value.

4. The method for providing computer-aided design processing of claim 1, further comprising:
receiving design input comprising part shapes and quantities for nested cutting.

5. The method for providing computer-aided design processing of claim 4
wherein nested cutting is designated to be performed by a manufacturing process.

6. The method for providing computer-aided design processing of claim 5:
wherein the manufacturing process comprises water jet cutting.

7. The method for providing computer-aided design processing of claim 6:
wherein water jet cutting comprises abrasive jet cutting.

8. The method for providing computer-aided design processing of claim 5:
wherein the manufacturing process includes at least one selected from the group consisting of: laser cutting, etching or treating; electron cutting, etching or treating; plasma cutting, etching or treating; water jet; abrasive water jet; sand blasting; bead blasting; milling; spray painting; electrodeposition; electro-discharge machining; wire EDM; UV cure; sintering; punch press process; ink jet manufacturing process; and sewing pattern design and manufacture.

9. The method for providing computer-aided design processing of claim 1, wherein the use price corresponds to a quantity of credits for deduction from a credit bank.

10. The method for providing computer-aided design processing of claim 1, further comprising:
displaying a design.

11. The method for providing computer-aided design processing of claim 1, further comprising:
receiving an acceptance of the use price; and
enabling output of a design.

12. The method for providing computer-aided design processing of claim 11, wherein
output of the design comprises output of tool control codes for fabricating the design.

13. The method for providing computer-aided design processing of claim 1, further comprising:
receiving an acceptance of the use price; and
processing an electronic payment.

14. The method for providing computer-aided design processing of claim 1, further comprising:
receiving an acceptance of the use price; and
processing an enabling code to enable design output.

15. The method for providing computer-aided design processing of claim 1, wherein the use price consists essentially of a license fee.

16. The method for providing computer-aided design processing of claim 1, wherein computer-aided design processing consists essentially of computer-aided manufacturing processing.

17. A computer-readable medium including computer-readable instructions for providing computer-aided design processing comprising:
computer-readable instructions for calculating a processing value based on part complexity; and
computer-readable instructions for offering a use price corresponding to the processing value.

18. The computer-readable medium including computer-readable instructions for providing computer-aided design processing of claim 17, further comprising:
computer-readable instructions for receiving design input.

19. The computer-readable medium including computer-readable instructions for providing computer-aided design processing of claim 17, wherein computer-readable instructions for calculating a processing value further comprises:
computer-readable instructions for calculating a time value corresponding to manual processing; and
wherein the calculated processing value corresponds to the time value.

20. The computer-readable medium including computer-readable instructions for providing computer-aided design processing of claim 17, further comprising:
computer-readable instructions for receiving design input comprising part shapes and quantities for nested cutting.

21. The computer-readable medium including computer-readable instructions for providing computer-aided design processing of claim 17:
wherein nested cutting is designated to be performed by a manufacturing process.

22. The computer-readable medium including computer-readable instructions for providing computer-aided design processing of claim 21:
wherein the manufacturing process comprises water jet cutting.

23. The computer-readable medium including computer-readable instructions for providing computer-aided design processing of claim 22:
wherein water jet cutting comprises abrasive jet cutting.

24. The computer-readable medium including computer-readable instructions for providing computer-aided design processing of claim 21:
wherein the manufacturing process includes at least one selected from the group consisting of: laser cutting, etching or treating; electron cutting, etching or treating; plasma cutting, etching or treating; water jet; abrasive water jet; sand blasting; bead blasting; milling; spray painting; electrodeposition; electro-discharge machining; wire EDM; UV cure; sintering; punch press process; ink jet manufacturing process; and sewing pattern design and manufacture.

25. The computer-readable medium including computer-readable instructions for providing computer-aided design processing of claim 17, wherein the use price corresponds to a quantity of credits for deduction from a credit bank.

26. The computer-readable medium including computer-readable instructions for providing computer-aided design processing of claim 17, further comprising:
computer-readable instructions for displaying a design.

27. The computer-readable medium including computer-readable instructions for providing computer-aided design processing of claim 17, further comprising:
computer-readable instructions for receiving an acceptance of the use price; and
computer-readable instructions for enabling output of a design.

28. The computer-readable medium including computer-readable instructions for providing computer-aided design processing of claim 27, wherein
output of the design comprises output of tool control codes for fabricating the design.

29. The computer-readable medium including computer-readable instructions for providing computer-aided design processing of claim 17, further comprising:
computer-readable instructions for receiving an acceptance of the use price; and
computer-readable instructions for processing an electronic payment.

30. The computer-readable medium including computer-readable instructions for providing computer-aided design processing of claim 17, further comprising:
computer-readable instructions for receiving an acceptance of the use price; and
computer-readable instructions for processing an enabling code to enable design output.

31. The computer-readable medium including computer-readable instructions for providing computer-aided design processing of claim 17, wherein the use price consists essentially of a license fee.

32. The computer-readable medium including computer-readable instructions for providing computer-aided design processing of claim 17, wherein computer-aided design processing consists essentially of computer-aided manufacturing processing.

33. A method for setting a fee for use of software comprising:
receiving input;
performing processing responsive to the received input;
tracking computer resource consumption during the performance of processing;
calculating a processing value corresponding to the tracked computer resource consumption; and
offering a fee corresponding to the processing value.

34. The method for setting a fee for use of software of claim 33, wherein
receiving input comprises receiving at least one shape; and wherein
performing processing responsive to the received input comprises determining a nesting pattern for cutting the at least one shape from raw stock.

35. The method for setting a fee for use of software of claim 34, wherein calculating a processing value corresponding to the tracked computer resource consumption comprises:
determining a time value corresponding substantially to an estimated time for a human performing the processing manually;
determining a time cost basis; and
multiplying the time value by the time cost basis to determine at least a component of the processing value.

36. The method for setting a fee for use of software of claim 34, wherein performing processing responsive to the received input includes calculating and displaying a pattern of nested parts.

37. The method for setting a fee for use of software of claim 34, wherein performing processing comprises performing provisional processing.

38. The method for setting a fee for use of software of claim 34, further comprising:
receiving an indication of acceptance of the fee; and
enabling output of data corresponding to output from the performed processing.

39. A computer-readable medium including computer-readable instructions for setting a fee for use of software comprising:
computer-readable instructions for receiving input;
computer-readable instructions for performing processing responsive to the received input;
computer-readable instructions for tracking computer resource consumption during the performance of processing;
computer-readable instructions for calculating a processing value corresponding to the tracked computer resource consumption; and
computer-readable instructions for offering a fee corresponding to the processing value.

40. The computer-readable medium including computer-readable instructions for setting a fee for use of software of claim 39 wherein:
receiving input comprises receiving at least one shape; and wherein
performing processing responsive to the received input comprises determining a nesting pattern for cutting the at least one shape from raw stock.

41. The computer-readable medium including computer-readable instructions for setting a fee for use of software of claim 39, wherein computer-readable instructions for calculating a processing value corresponding to the tracked computer resource consumption comprises:
computer-readable instructions for determining a time value corresponding substantially to an estimated time for a human performing the processing manually;
computer-readable instructions for determining a time cost basis; and
computer-readable instructions for multiplying the time value by the time cost basis to determine at least a component of the processing value.

42. The computer-readable medium including computer-readable instructions for setting a fee for use of software of claim 39, wherein computer-readable instructions for performing processing responsive to the received input includes computer-readable instructions for calculating and displaying a pattern of nested parts.

43. The computer-readable medium including computer-readable instructions for setting a fee for use of software of claim 39, wherein performing processing comprises performing provisional processing.

44. The computer-readable medium including computer-readable instructions for setting a fee for use of software of claim 39, further comprising:
computer-readable instructions for receiving an indication of acceptance of the fee; and
computer-readable instructions for enabling output of data corresponding to output from the performed processing.

45. A method for setting a fee for use of software comprising:
receiving input;
analyzing the received input to estimate a processing complexity;
calculating a processing value corresponding to the estimated processing complexity; and
offering a fee corresponding to the processing value.

46. The method for setting a fee for use of software of claim 45, wherein:
receiving input comprises receiving at least one shape; and wherein the processing complexity corresponds to the complexity of determining a nesting pattern for cutting the at least one shape from raw stock.

47. The method for setting a fee for use of software of claim 45, wherein calculating a processing value corresponding to the estimated processing complexity comprises:
determining a time value corresponding substantially to an estimated time for a human performing the processing manually;
determining a time cost basis; and
multiplying the time value by the time cost basis to determine at least a component of the processing value.

48. The method for setting a fee for use of software of claim 45, wherein analyzing the received input to estimate a processing complexity comprises determining at least one selected from the group consisting of shape complexity, process constraints, shape quantities, assembly specifications, raw stock specifications, raw stock size or sizes, draft angle requirements, tolerances, surface finish requirements, anisotrophy, part curvature, part symmetry, size ratio between parts, ratio of part size to lateral depth of features, number of different shapes, dissimilarity of shapes, raw stock cost, shape price target, and tool path efficiency target.

49. The method for setting a fee for use of software of claim 45, further comprising:
receiving an indication of acceptance of the fee; and
enabling the performance of processing responsive to the received input.

50. A computer-readable medium including computer-readable instructions for setting a fee for use of software comprising:
computer-readable instructions for receiving input;
computer-readable instructions for analyzing the received input to estimate a processing complexity;
computer-readable instructions for calculating a processing value corresponding to the estimated processing complexity; and
computer-readable instructions for offering a fee corresponding to the processing value.

51. The computer-readable medium including computer-readable instructions for setting a fee for use of software of claim 50, wherein:
receiving input comprises receiving at least one shape; and wherein
the processing complexity corresponds to the complexity of determining a nesting pattern for cutting the at least one shape from raw stock.

52. The computer-readable medium including computer-readable instructions for setting a fee for use of software of claim 50, wherein computer-readable instructions for calculating a processing value corresponding to the estimated processing complexity comprises:
computer-readable instructions for determining a time value corresponding substantially to an estimated time for a human performing the processing manually;
computer-readable instructions for determining a time cost basis; and
computer-readable instructions for multiplying the time value by the time cost basis to determine at least a component of the processing value.

53. The computer-readable medium including computer-readable instructions for setting a fee for use of software of claim 50, wherein analyzing the received input to estimate a processing complexity comprises determining at least one selected from the group consisting of: number of corners in a part, number of arcs in a part, number of features in a part, number of elements making up a part, curvature, symmetry, number of parts to nest, number of different parts to nest; dissimilarity of parts, complexity of each part, complexity of the sheet to nest, selection of common line cut, selection of automatically tabbed pieces, selection of automatically creating a tool path sequence, selection of whether to bridge pieces, process constraints, assembly specifications, raw stock specifications, raw stock size, number of raw stock sizes, draft angle requirements, tolerances, surface finish requirements, grain, anisotropy of the raw material, the need to control anistropy of material in a part, raw stock cost, shape price target, and tool path efficiency target.

54. The computer-readable medium including computer-readable instructions for setting a fee for use of software of claim 50, further comprising:
computer-readable instructions for receiving an indication of acceptance of the fee; and
computer-readable instructions for enabling the performance of processing responsive to the received input.
